(19) United States
(12) Patent Application Publication
(10) Pub. No.: US 2011/0163216 A1
(43) Pub. Date: Jul. 7, 2011

(54) Highly Extensible and Easily Operable Telescopic Device

(76) Inventor: Han-Ching Huang, Xianxi Township (TW)

(21) Appl. No.: 12/683,542

(22) Filed: Jan. 7, 2010

(51) Int. Cl. F16M 13/00

(52) U.S. Cl. 248/354.7

(57) ABSTRACT

A telescopic device includes a first tube, a second tube in which the first tube is telescopically inserted, a third tube in which the second tube is telescopically inserted, a guiding unit for preventing rotation of the second tube in the third tube, a maneuvering unit for retaining the first tube in a desired position relative to the second tube, and a lock for locking the second tube in a desired position relative to the third tube.

### BACKGROUND OF INVENTION

1. Field of Invention

The present invention relates to a telescopic device for supporting stuff and, more particularly, to a highly extensible and easily operable telescopic device.

2. Related Prior Art

Referring to FIG. 1, there is shown a first conventional telescopic device 10 for which Taiwanese Utility Model M293988 has been issued to the applicant of the present application. The telescopic device 10 includes an internal tube 11 and an external tube 12. A pad 15 is attached to the internal tube 11. Another pad 15 is attached to the external tube 12. A plurality of recessed portions 14 is defined in an external face of the internal tube 11. Each of the recessed portions 14 is a cavity or an aperture for receiving a portion of a maneuvering unit 13 provided on the external tube 12. Thus, an effective length of the telescopic device 10 is retained at a desired value while the pads 15 are abutted against two opposite walls of a container for example. Hence, the telescopic device 10 can retain goods in position in the container. The telescopic device 10 is effective except that the effective length is adjustable in a small range. It seems too long for storage when it is completely retracted. On the other hand, it seems too short for use in another place than the container when it is completed extended.

Referring to FIGS. 2 through 4, a second conventional telescopic device includes an internal tube 11 and an external tube 12. An aperture 16 is defined in the internal tube 11. A series of apertures 17 is defined in the external tube 12. A V-shaped leaf spring 20 is located in the internal tube 11. An end of the leaf spring 20 is secured to an internal face of the internal tube 11. A peg 21 is secured to another end of the leaf spring 20. The peg 21 is inserted in the aperture 16 and can be inserted in a selected one of the apertures 17 to retain the effective length of the telescopic device in a desired value. A serious problem is however encountered in the operation of the second conventional telescopic device. It is difficult to insert the peg 21 in a selected one of the apertures 17 because the tubes 11 and 12, as round tubes, are rotational relative to each other.

The present invention is therefore intended to obviate or at least alleviate the problems encountered in prior art.

### SUMMARY OF INVENTION

It is an objective of the present invention to provide a highly extensible telescopic device.

It is another objective of the present invention to provide an easily operable telescopic device

To achieve the foregoing objectives, the telescopic device includes a first tube, a second tube in which the first tube is telescopically inserted, a third tube in which the second tube is telescopically inserted, a guiding unit for preventing rotation of the second tube in the third tube, a maneuvering unit for retaining the first tube in a desired position relative to the second tube, and a lock for locking the second tube in a desired position relative to the third tube.

Other objectives, advantages and features of the present invention will become apparent from the following description referring to the attached drawings.

### BRIEF DESCRIPTION OF DRAWINGS

The present invention will be described via detailed illustration of the preferred embodiment versus the prior art referring to the attached drawings where:

FIG. 1 is a perspective view of a conventional telescopic device;

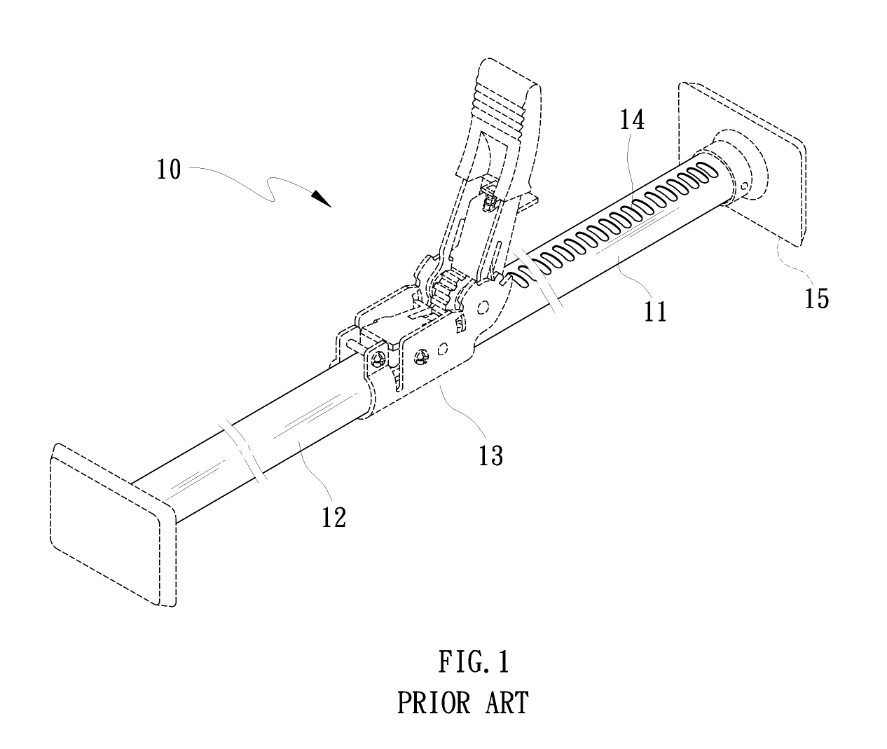

FIG. 2 is an exploded view of another conventional telescopic device;

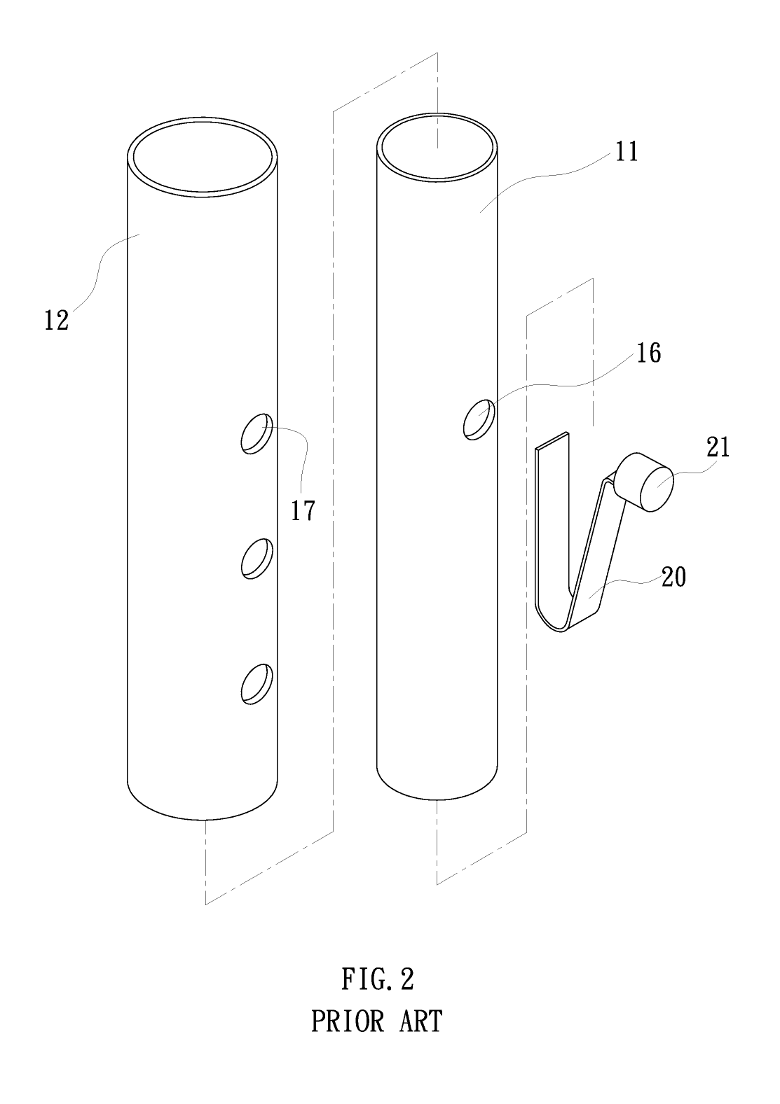

FIG. 3 is a cross-sectional view of the conventional telescopic device shown in FIG. 2;

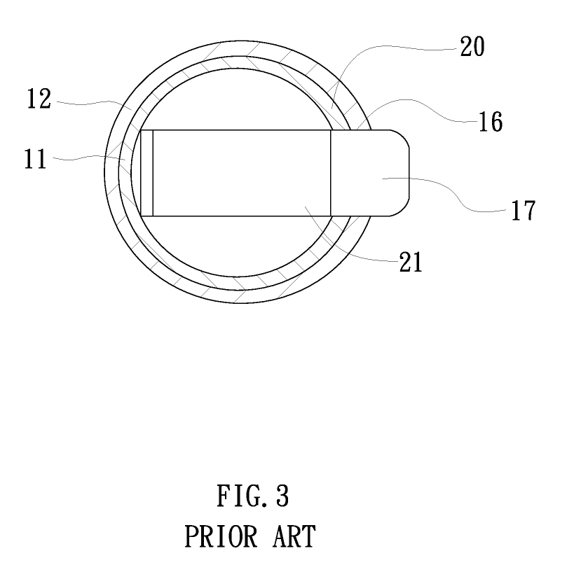

FIG. 4 is another cross-sectional view of the conventional telescopic device shown in FIG. 3;

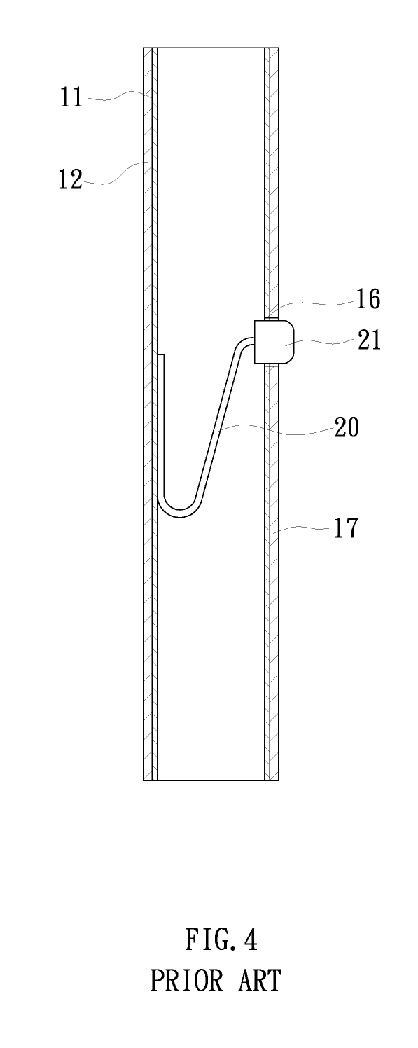

FIG. 5 is a perspective view of a highly extensible and easily operable telescopic device according to the preferred embodiment of the present invention;

FIG. 6 is a side view of the telescopic device shown in FIG. 5;

FIG. 7 is a cross-sectional view of the telescopic device of FIG. 5; and

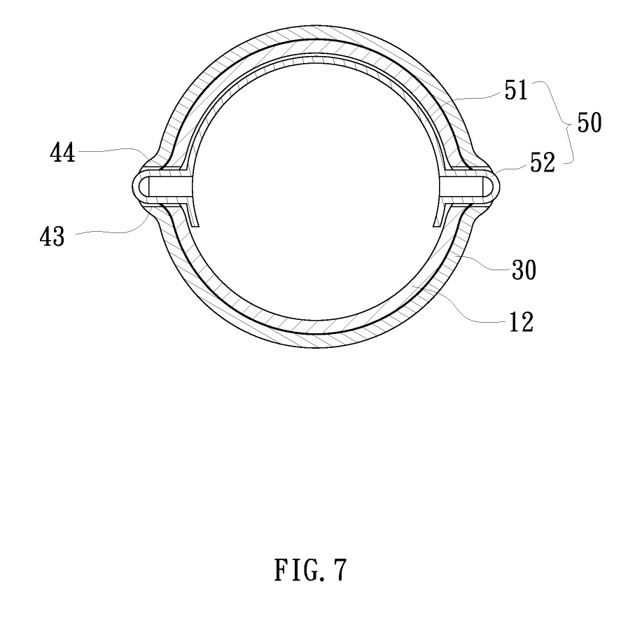

FIG. 8 is a cross-sectional view of the telescopic device of FIG. 7.

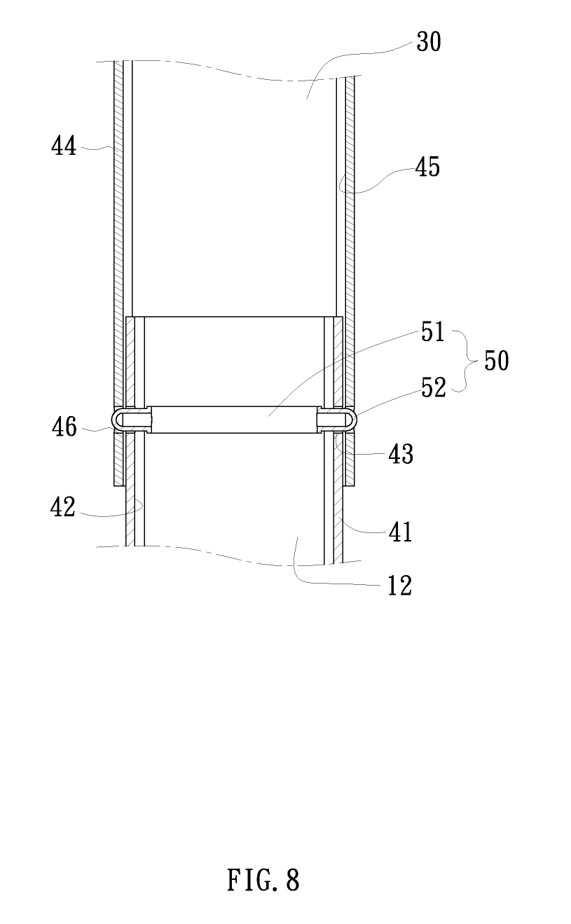

### DETAILED DESCRIPTION OF PREFERRED EMBODIMENT

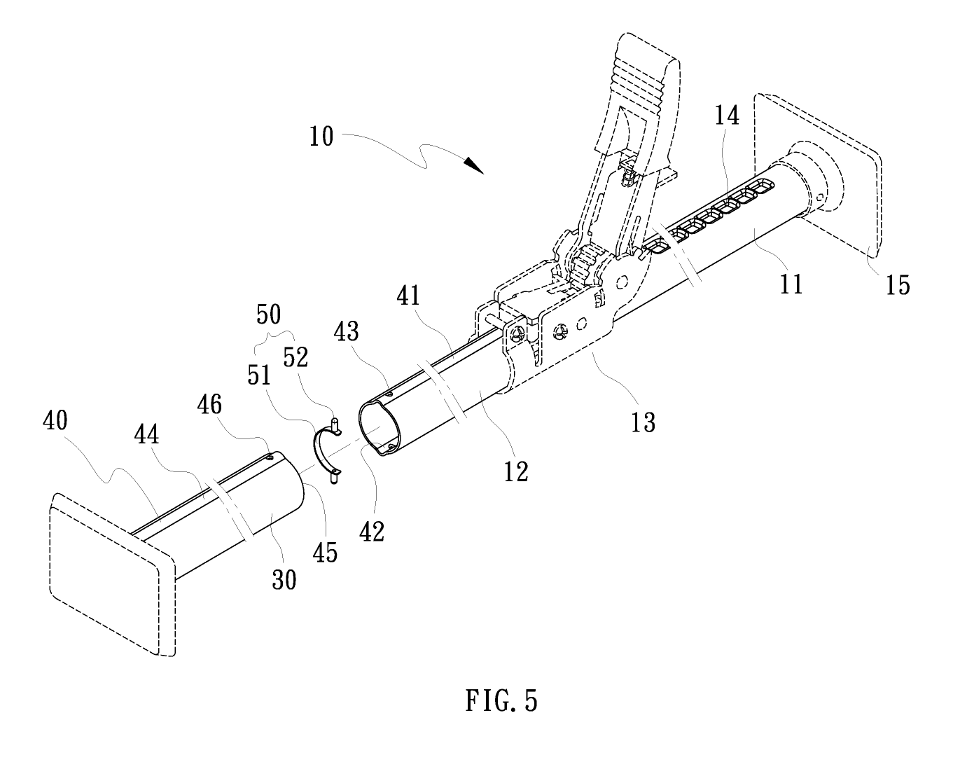

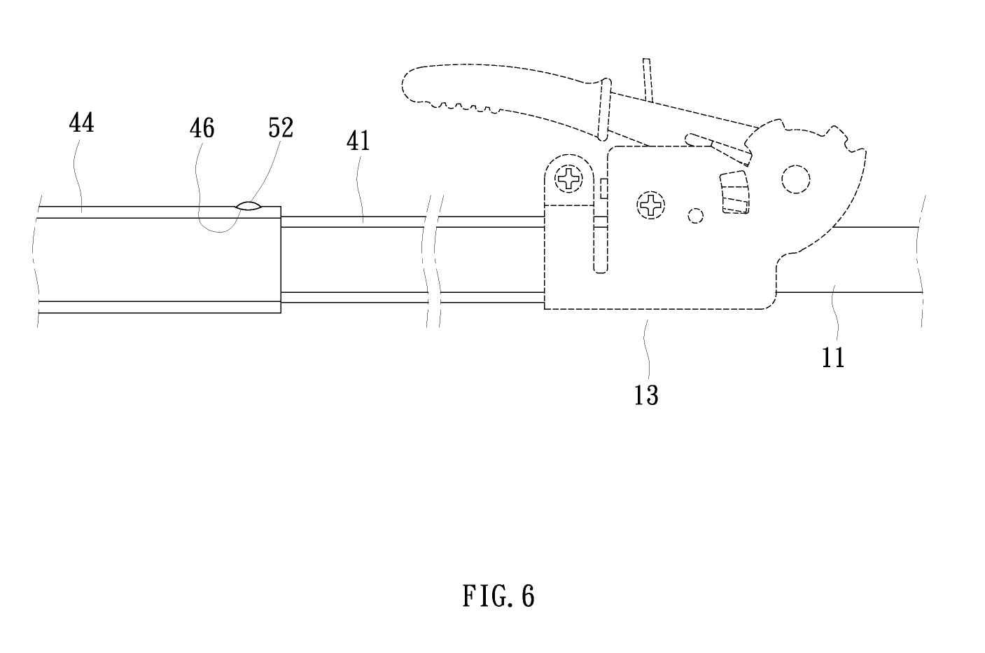

Referring to FIGS. 5 and 6, a telescopic device 10 includes a first tube 11, a second tube 12 and a third tube 30 according to the preferred embodiment of the present invention. The first tube 11 can be inserted in the second tube 12 at least partially. The second tube 12 can be inserted in the third tube 30 at least partially. A pad 15 is attached to an end of the internal tube 11. Another pad 15 is attached to an end of the third tube 30.

A plurality of recessed portions 14 is defined in an external face of the internal tube 11. Each of the recessed portions 14 is a cavity or an aperture for receiving a portion of a maneuvering unit 13 provided on the external tube 12. The first tube 11, the second tube 12 and the maneuvering unit 13 will not be described in detail for being identical to their counterparts in Taiwanese Utility Model M293988 issued to the applicant of the present application.

Two opposite ridges 41 are longitudinally formed on an external side of the second tube 12 by pressing the second tube 12 from an internal side with hydraulic pressure. Thus, two grooves 42 are defined on the internal side of the second tube 12 corresponding to the ridges 41. Two opposite apertures 43 are defined in the second tube 12, corresponding to the ridges 41 or the grooves 42.

Two opposite ridges 44 are longitudinally formed on an external side of the third tube 30 by pressing the third tube 30 from an internal side with hydraulic pressure. Thus, two grooves 45 are defined on the internal side of the third tube 30 corresponding to the ridges 44. Two opposite apertures 46 are defined in the third tube 30, corresponding to the ridges 44 or the grooves 45. Each of the apertures 46 can however be replaced with a series of apertures in another embodiment. The ridges 42 and 44 together form a guiding device 40 for ensuring smooth relative movement between the second tube 12 and the third tube 30.

There is used a lock 50 for locking the second tube 12 relative to the third tube 30. The lock 50 includes a U-shaped leaf spring 51 and two pegs 52 each secured to an end of the leaf spring 51.

In assembly, the lock 50 is located in the second tube 12. The second tube 12 is movably inserted in the third tube 30. The ridges 41 are movably located in the grooves 45. The pegs 52 are inserted in the apertures 43. When the pegs 52 are located outside the apertures 46, the second tube 12 is movable relative to the third tube 30. The pegs 52 can be inserted in the apertures 46 to lock the second tube 12 relative to the third tube 30.

In use, most of the second tube 12 is extended from the third tube 30, and the pegs 52 are inserted in the apertures 46. Then, the maneuvering unit 13 is operated to extend the first tube 11 from the second tube 12 so that the pads 15 are abutted against two opposite walls of a container for example. Thus, an effective length of the telescopic device 10 is retained at a desired value while the pads 15 are abutted against the opposite walls of the container. Hence, the telescopic device 10 can retain goods in position in the container.

The telescopic device 10 of the present invention exhibits at least two advantages over the conventional telescopic devices discussed in the RELATED PRIOR ART. Firstly, the effective length of the telescopic device 10 is adjustable in a large range for including three tubes 11, 12 and 30 telescopically connected to one another. For a same maximum of the effective length in use, the effective length of the telescopic device 10 of the present invention can be adjusted to a smaller minimum for storage than the conventional telescopic devices. On the other hand, for a same minimum of the effective length for storage, the effective length of the telescopic device 10 of the present invention can be adjusted to a larger maximum in use than the conventional telescopic devices.

Secondly, it is easier to insert the pegs 52 in the apertures 46 of the third tube 30 of the telescopic device of the present invention than to insert the peg in a selected one of the apertures of the external tube of the second conventional telescopic device. This is because the insertion of the ridges 41 in the grooves 45 prevents the second tube 12 from rotation relative to the third tube 30.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A telescopic device comprising:
a first tube;
a second tube in which the first tube is telescopically inserted;
a third tube in which the second tube is telescopically inserted;
a guiding unit for preventing rotation of the second tube in the third tube;
a maneuvering unit for retaining the first tube in a desired position relative to the second tube; and
a lock for locking the second tube in a desired position relative to the third tube.

2. The telescopic device according to claim 1, wherein the guiding unit includes:
at least one ridge longitudinally formed on an external side of the second tube; and
at least one groove defined on an internal side of the third tube for receiving the ridge.

3. The telescopic device according to claim 2, wherein the second tube includes at least one aperture defined in the ridge, wherein the third tube includes at least one aperture defined therein within the groove, wherein the lock includes a leaf spring located in the second tube and at least one peg formed on the leaf spring, wherein the peg is inserted in the aperture of the second tube and can be inserted in the aperture of the third tube to lock the second tube relative to the third tube.

4. The telescopic device according to claim 1, wherein the second tube includes at least one aperture defined therein, wherein the third tube includes at least one aperture defined therein, wherein the lock includes a leaf spring located in the second tube and at least one peg formed on the leaf spring, wherein the peg is inserted in the aperture of the second tube and can be inserted in the aperture of the third tube to lock the second tube relative to the third tube.
